(19) United States
(12) Patent Application Publication
(10) Pub. No.: US 2002/0010648 A1
(43) Pub. Date: Jan. 24, 2002

(54) Service exchanging system and method

(76) Inventors: Soung-joon Park, Kuri City (KR); Jin-hyun Park, Koyang city (KR)

Correspondence Address: LARSON & TAYLOR, PLC, 1199 NORTH FAIRFAX STREET, SUITE 900, ALEXANDRIA, VA, 22314, US

(21) Appl. No.: 09/891,245

(22) Filed: Jun. 27, 2001

(30) Foreign Application Priority Data
Jun. 30, 2000 (KR) 36993/2000

(51) Int. Cl. G06F 17/60

(52) U.S. Cl. 705/26

(57) ABSTRACT

Disclosed is a service exchanging system and method. The system includes a consumer database for storing therein consumer information including schedule information inputted from a consumer who desires to receive a specified service, and a control part for requesting the consumer to register the consumer information through a network, providing the schedule information stored in the consumer database to a service provider, and providing to the consumer details of the service that corresponds to the schedule information provided from the service provider who provides the service. Accordingly, the service is provided based on the schedule information of the consumer, and thus it can offer convenience to the consumer with the profit of the service provider increased.

### BACKGROUND OF THE INVENTION

1. Field of the Invention

The present invention relates to a service exchanging system and method, and more particularly, to a service exchanging system and method that can provide a service in accordance with a consumer's schedule.

2. Description of the Related Art

In an electronic commerce carried on the Internet, diverse goods and services are exchanged, and the type of exchange is classified into auction, Dutch auction, sale to order, etc.

In case of purchasing goods through the Internet, a consumer first collect information on the goods to be purchased by surfing various kinds of electronic commerce web sites, and then purchases the goods through a web site that provides a low price and has a profitable purchasing condition, based on the collected information. Meanwhile, in order to help the consumer to promptly collect the information on the goods, there exist operating sites that provide compared prices of goods selling through respective electronic commerce web sites, and auction sites or Dutch auction sites that sell at a bargain.

On the contrary, in case of service providing sites run by travel agencies, movers, shipping agents, lodging agents, etc., they have nothing particular or do not have special merits except that commercial transactions carried by off-line are merely moved on-line.

Specifically, the consumer, who intends to be offered a service from respective service providing sites, collects information by directly accessing the respective service providing sites, and selects the service most suitable to him/her among the provided services based on the collected information from the respective service providing sites. Also, if the desired service does not exist on-line, the consumer should contact service providers on-line or off-line, and modify particulars of the service in accordance with his/her schedule.

Accordingly, if the consumer desires to be offered any service, he/she should collect information by visiting a plurality of service providing sites one by one, and a separate negotiation with the respective service providers is also requested. This process is troublesome and time-consuming. Also, the consumer has no choice but to select one among predetermined services, and in case that the consumer wishes a custom service, he/she should pay additional charges.

In consequence, it is required to use a suitable custom service in accordance with the consumer's schedule to save time and cost.

### SUMMARY OF THE INVENTION

Therefore, an object of the invention is to solve the problems involved in the related art, and to provide a service exchanging system and method that can provide a suitable service in accordance with a consumer's schedule.

In accordance with the present invention, this object is accomplished by providing a service exchanging system comprising a consumer database for storing therein consumer information including schedule information inputted from a consumer who desires to receive a specified service, and a control part for requesting the consumer to register the consumer information through a network, providing the schedule information stored in the consumer database to a service provider who provides the service, and providing to the consumer details of the service that corresponds to the schedule information provided from the service provider.

Preferably, the service exchanging system further comprises a service provider database for storing therein service provider information including credit valuation information valued according to assets and business results of the service provider, wherein the service provider decides to provide the service, the control part provides to the consumer the service provider information along with the service particulars to help the consumer to select a desired service provider among a plurality of service providers.

The consumer database stores therein consumer's credit valuation information valued according to the consumer's credit transaction information from financial agencies, and particulars of the consumer's schedule reservation and cancellation, and the control part provides the credit valuation information along with the schedule information to the service provider to prevent the service provider from being unprofitable in the transactions with the consumer.

The service exchanging system according to the present invention further includes a communication part for providing the consumer information to the service provider through mobile communications.

Preferably, the control part classifies the consumers according to the kind of service, and provides the consumer information on the respective classified consumers to the service provider of the corresponding service.

In another aspect of the present invention, there is provided a service exchanging method comprising the steps of requesting a consumer who desires to receive a specified service to input consumer information including schedule information, providing the consumer information including the schedule information to a service provider that provides the service, making the consumer input details of the service to be provided from the service provider to the consumer, and providing the details of the service to the consumer.

Preferably, the service exchanging method further comprises the step of providing to the consumer service provider information including credit valuation information valued according to assets and business results of the service provider in case that the service provider decides to provide the service to help the consumer to select a desired one among a plurality of service providers.

Preferably, the service exchanging method further comprises the step of providing to the service provider consumer's credit valuation information including consumer's credit transaction information from financial agencies, and particulars of the consumer's schedule reservation and cancellation to prevent the service provider from being unprofitable in the transactions with the consumer.

Preferably, the service exchanging method according to the present invention further comprises the step of providing the consumer information to the service provider through mobile communications for the convenience of the service provider.

Preferably, the service exchanging method further comprises the steps of classifying the consumers according to the kind of the service provider's service, providing the consumer information on the respective classified consumers to the service provider of the corresponding service, and providing a service purchase condition from the service provider to the respective consumers.

### BRIEF DESCRIPTION OF THE DRAWINGS

The above object, and other features and advantages of the present invention will become more apparent after a reading of the following detailed description when taken in conjunction with the drawings, in which:

FIG. 1 is a block diagram illustrating the construction of the service exchanging system according to the present invention;

FIG. 2 is a block diagram illustrating the construction of the service exchanging server of FIG. 1;

FIG. 3 is a view illustrating an example of a schedule list of a site according to the service exchanging server of FIG. 2 displayed on a screen; and

FIGS. 4 and 5 are views illustrating examples of a schedule information window activated when a certain schedule is selected in the schedule list of FIG. 3.

### DETAILED DESCRIPTION OF THE PREFERRED EMBODIMENT

Hereinafter, the service exchanging system in accordance with the present invention will be described with respect to the embodiment illustrated in the accompanying drawings.

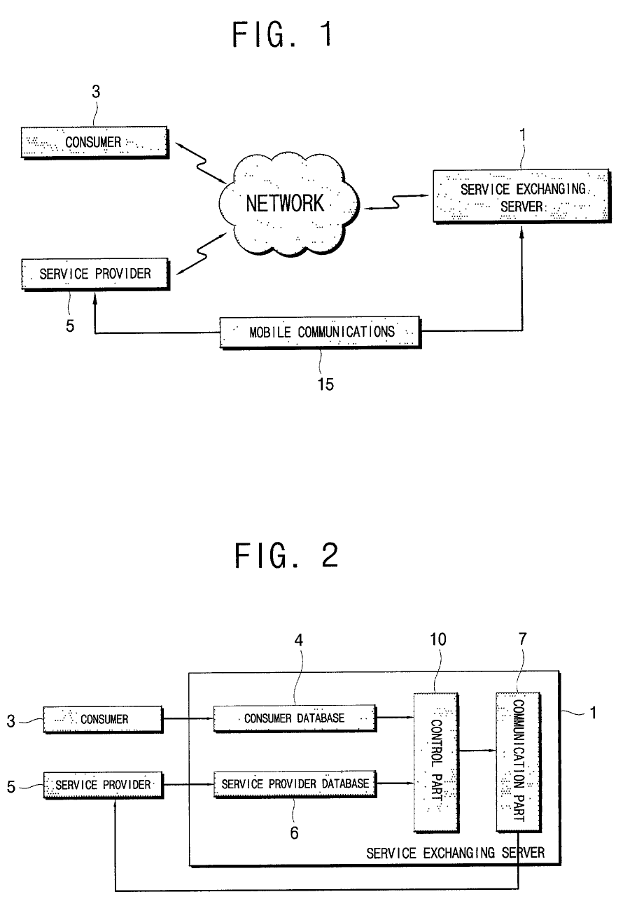

As shown in FIG. 1, the service exchanging system according to the present invention includes a plurality of consumers 3 who desire to purchase services, a plurality of service providers 5 that desire to sell services, and a service exchanging server 1 having a service exchanging site for providing service purchasing conditions of the consumers 3 to the service providers 5 and providing service selling conditions of the service providers to the consumers 3.

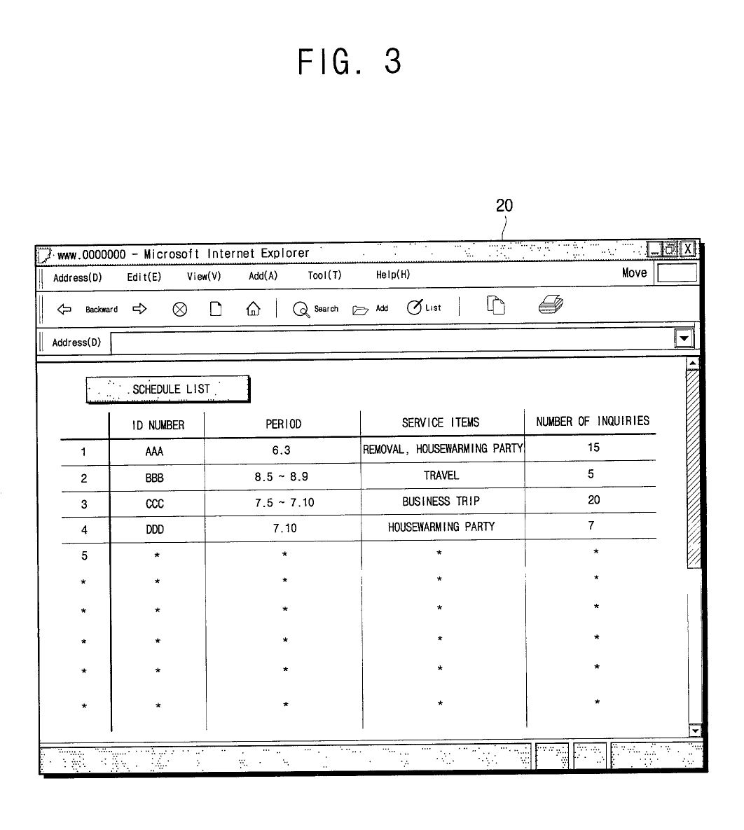

The service exchanging server 1, as shown in FIG. 2, includes a consumer database 4 for storing therein consumer information, a service provider database 6 for storing therein service provider information, a control part 10 for providing a purchasing condition of a consumer 3 to a service provider 5, and providing the service provider information to the consumer 3 in accordance with the selection of the service provider 5, and a communication part 7 for providing the consumer information to the service provider 5 through a mobile communication agency 5.

The consumer information stored in the consumer database 4 includes an identifier (ID) code given to the respective consumer 3 so that the consumer 3 can purchase the service on the service exchanging server 1 using the ID code, schedule information related to the consumer's business or daily life, and personal information of the consumer 3. The consumer 3 may be of diverse types such as individuals, juridical persons, enterprises, etc., that need the service, and thus the schedule information may include diverse types of schedules such as travel, removal, etc., related to the individuals, and travel in a party, removal, expansion, business trip, etc., related to the juridical persons or enterprises. The ID codes and schedule information among the consumer information are provided to the service providers 5 from time to time, and if a contract with a specified service provider 5 is made, the information required for a custom service among the personal information of the consumer 3, for example, information on a wage level, property, etc., is provided to the service provider. Accordingly, the service provider 5 can determine the details of service in accordance with the financial conditions of the consumer 3.

In the service provider database 6 is stored credit valuation data of the seller including assets and business results of the service provider 5, kinds of services provided by the service provider 5, and service provider information including kinds of goods corresponding to the kinds of services. For example, the service provider 5 may be travel agencies, movers, catering agents, shipping agents, lodging agents, etc.

If the consumer 3 and the service provider 5 access the service exchanging site operated by such a service exchanging server 1, the control part 10 requests the consumer 3 and the service provider 5 to input the consumer information and the service provider information, respectively. When they complete inputting information required for gaining membership, the control part 1 gives the consumer 3 a separate ID code for the security of the consumer 3. Meanwhile, the service exchanging server 1 values the credit of the consumer 3 and the service provider 5 through a separate credit valuation agency or self credit valuation in on-line or off-line. At this time, the credit of the service provider 5 is valued according to its assets or working state, and the credit of the consumer 3 is valued according to the financial state in the consumer's bank account or credit card transaction. The credit valuation with respect to the consumer 3 and the service provider 5 is performed at regular or irregular intervals while the consumer 3 and the service provider 5 use the service exchanging site, and in case that the service provider 5 transacts the service with the consumer 3 through the service exchanging site, whether the service transaction has been performed is added to the contents of the credit valuation.

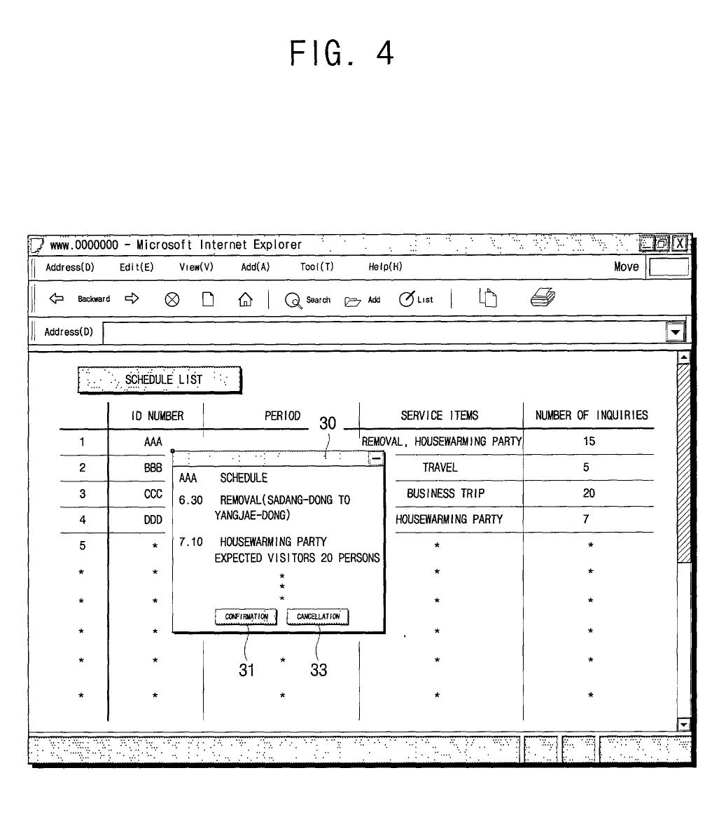

If the subscription of the consumer 3 is completed, the schedule information of the consumer, as shown in FIG. 3, is presented on a schedule list screen 20 provided from the service exchanging site. On the schedule list screen 20 are presented an ID number of the consumer 3, period of the main event that requires the service among the schedules of the consumer 3, kind of service, and the number of inquiries, respectively. Here, if the consumer clicks the terms of the ID number and the service, detailed schedule information of the consumer 3 is displayed in the form of a pop-up.

Meanwhile, the service provider 5 selects the consumer 3 who desires the service that matches its own enterprise type through the schedule list screen 20. If the service provider 5 is the mover or catering agent, the service provider 5 would want to search in detail the schedule information of the consumer 3, that corresponds to the ID mark AAA the service item of which indicates removal, housewarming party in the schedule list. And, in case that the service provider 5 is the travel agency, the service provider 5 would want to search in detail the schedule information of the consumer 3, that corresponds to the ID mark BBB the service item of which indicates travel in the schedule list.

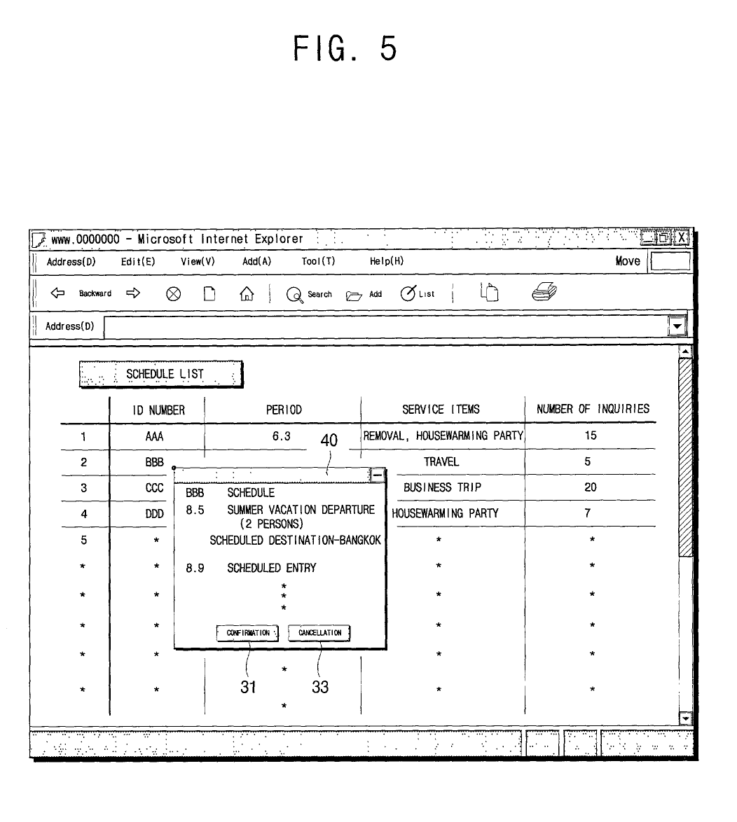

In case that the service provider 5 is the mover, the service provider 5 clicks the ID mark AAA or its service item of the consumer 3, and as shown in FIG. 4, a schedule information window 30 for presenting the detailed schedule information of the consumer 3 is displayed to the service provider 5. On the schedule information window 30 is presented a moving plan including the moving date, moving district, area of the house to move into, etc. Also, on the lower portion of the schedule information window are displayed a confirmation button 31 and a cancellation button 33 for determining whether to select the schedule information. If the service provider 5 wishes to provide the service, that is, if the vehicle and laborer(s) for removal are available, the service provider selects the confirmation button 33. In this case, the control part 10 of the service exchanging server 1 provides the service provider information on the service provider 5 to the consumer 3. The service provider 5 and the consumer 3 communicate with each other through a mail, telephone, visit, etc., and mutually negotiate with the service purchase condition presented by the consumer 3 and the service selling condition presented by the service provider 5. At this time, if a plurality of service providers exist, the consumer 3 may select the service provider 5 in accordance with the service provider information or service selling condition. Also, a plurality of service providers may carry out a Dutch auction to the purchase condition of the consumer 3 to choose the service provider 5. In this case, no further negotiation is required for matching the conditions between the consumer 3 and the service provider 5.

In case that the service provider 5 is the travel agency, the service provider 5 clicks the consumer 3 whose ID mark is AAA, and as shown in FIG. 5, a schedule information window 40 is displayed to the service provider 5. On the schedule information window 30 is presented a departure date, returning date, scheduled destination, number of accompanying persons, etc. If the service provider 5 wishes to transact, the service provider selects the confirmation button. At this time, if a plurality of service providers exist, the consumer 3 may select the service provider 5 for providing him/she with best offering for the purchase condition of the consumer 3, while one service provider 5 exists, the consumer 3 and the service provider 3 mutually negotiate about the service purchase condition presented by the consumer 3 and the service selling condition presented by the service provider 5.

Meanwhile, the service exchanging server 1 may provide the service for automatically providing the consumer information to the service provider 5 in accordance with the request of the service provider 5. That is, if the consumer information is received from a plurality of consumers 3, the control part 10 of the service exchanging server 1 classifies the consumers 3 according to the service items of the service provider 5, and provides the purchase condition including the information on the classified consumer 3, for example, the date when the consumer 3 wishes to receive the service, details of the service, etc., to the corresponding service provider 5. Accordingly, the respective service provider 5 can receive the information on the plurality of consumers 3 at a time, without the necessity of directly collecting the information on the consumers 3 by searching the schedule list screen 20. Also, the service provider 5 can at once present the selling condition to the plurality of consumers 3 that have similar purchase conditions through the service exchanging server 1, and thus the service provider 5 can save the time and cost.

Also, the service exchanging server 1 can provide the consumer information to the service providers 5 by way of a text message, voice message, etc., by accessing the mobile communication agency of the service provider 5 through the communication part 7. Accordingly, the service provider 5 can conveniently receive the consumer information at any time and in any place using the mobile communication device even without directly accessing the service exchanging server 1, and thereby the convenience of the service provider can be afforded.

As described above, the present invention can provide to the service provider 5 the schedule information of the consumer 3 that wishes for the service corresponding to the service provider's type of business, and provide to the consumer 3 the service selling conditions based on the schedule information of the consumer 3.

Accordingly, the consumer 3 can receive the desired service only by the public offering of its own schedule information, and thus can save the time and cost for selecting one among a plurality of service providers that provides a low-priced and good-quality service. Meanwhile, the service provider 5 can sell the service to the consumers 3 that have no information on the service provider or have not directly contacted the service provider on-line or off-line. Also, the service provider 5 can propose the service selling condition simultaneously to a plurality of consumers 3 that match the selling condition, and thus the effective and increasing service selling can be achieved.

Meanwhile, since the activities of the consumer can be analyzed based on the results of such service transaction, the service provider 5 can develop and provide services that suit the consumer's taste.

From the foregoing, it will be apparent that the present invention provides the advantages that it provides the service based on the schedule information of the consumer, and thus can offer convenience to the consumer with the profit of the service provider increased.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A service exchanging system comprising:
a consumer database for storing therein consumer information including schedule information inputted from a consumer who desires to receive a specified service; and
a control part for requesting the consumer to register the consumer information through a network, providing the schedule information stored in the consumer database to a service provider who provides the service, and providing to the consumer details of the service that corresponds to the schedule information provided from the service provider.

2. The service exchanging system of claim 1, further comprising a service provider database for storing therein service provider information including credit valuation information valued according to assets and business results of the service provider, wherein in case that the service provider decides to provide the service, the control part provides to the consumer the service provider information along with the service particulars.

3. The service exchanging system of claim 2, wherein the consumer database stores therein consumer's credit valuation information valued according to the consumer's credit transaction information from financial agencies, and particulars of the consumer's schedule reservation and cancellation, and the control part provides the credit valuation information along with the schedule information to the service provider.

4. The service exchanging system of claim 3, further comprising a communication part for providing the consumer information to the service provider through mobile communications.

5. The service exchanging system of claim 4, wherein the control part classifies the consumers according to the kind of service, and provides the consumer information on the respective classified consumers to the service provider of the corresponding service.

6. A service exchanging method comprising the steps of:
requesting a consumer who desires to receive a specified service to input consumer information including schedule information;
providing the consumer information including the schedule information to a service provider that provides the service;
making the consumer input details of the service to be provided from the service provider to the consumer; and
providing the details of the service to the consumer.

7. The service exchanging method of claim 6, further comprising the step of providing to the consumer service provider information including credit valuation information valued according to assets and business results of the service provider in case that the service provider decides to provide the service.

8. The service exchanging method of claim 7, further comprising the step of providing to the service provider consumer's credit valuation information including consumer's credit transaction information from financial agencies, and particulars of the consumer's schedule reservation and cancellation.

9. The service exchanging method of claim 8, further comprising the step of providing the consumer information to the service provider through mobile communications.

10. The service exchanging method of claim 9, further comprising the steps of:
classifying the consumers according to the kind of the service provider's service;
providing the consumer information on the respective classified consumers to the service provider of the corresponding service; and
providing a service purchase condition from the service provider to the respective consumers.
